(19) United States
(12) Patent Application Publication
(10) Pub. No.: US 2007/0057955 A1
(43) Pub. Date: Mar. 15, 2007

(54) Display panels and methods and apparatus for driving the same

(76) Inventor: Brent Thomas McKay, Newport Beach, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/513,817

(22) Filed: Aug. 30, 2006

Related U.S. Application Data
(60) Provisional application No. 60/712,318, filed on Aug. 31, 2005.

(51) Int. Cl. G09G 5/36

(52) U.S. Cl. 345/550

(57) ABSTRACT

Methods and apparatus for mitigating or substantially eliminating pixel burn-in on phosphor-based display panels. A visual display includes a display installation and a computer. The display installation may include a display panel having including a plurality of pixels each with a bit depth and an interface for receiving a video input and for driving the display panel. The computer is configured to determine a primary burn value for each of the pixels for a primary period of time, and to determine a secondary burn value for each of the pixels for a secondary period of time. The computer determines the secondary burn values such that when a pixel is driven at the secondary burn value thereof for the secondary period of time, an average value of the pixel for the primary and secondary periods of time is approximately equal to one-half of the bit depth of the pixel.

### CROSS REFERENCE TO RELATED APPLICATIONS

The present application claims priority benefit under 35 U.S.C. § 119(e) to U.S. Provisional Patent Application Ser. No. 60/712,318, filed Aug. 31, 2005, entitled “Display Panels And Methods And Apparatus For Driving The Same;” the present application incorporates the foregoing disclosure herein by reference.

### FIELD OF THE INVENTION

The present invention relates to electronic display panels, such as plasma display panels (PDPs), LCDs, and other light-emitting display technologies, and to methods and apparatus for driving display panels. An example of one of the embodiments of the invention is large-screen electronic displays that are used as public information systems or digital signage.

### BACKGROUND

Recent years have seen considerable advances in the dynamic information presentation marketplace, particularly with regard to the use of plasma display technology. Conventionally, the dynamic advertising market uses networked plasma-based display systems because of its excellent optical characteristics, thin profile and wide viewing angle. Since the original commercial introduction of 42-inch plasma display products, use of this technology as a “Digital Ad Board” has become fairly commonplace. In a Digital Ad Board application the entire screen is typically used to display an “ad loop,” or a series of full-screen advertisements that cycle on a regular basis.

One peculiarity of plasma display technology is its tendency to “burn in” if a static image is displayed in the same location over a continued period of time. This burn-in is a physical property of plasma display technology and is not likely to be eliminated through % core technology advancements. The burn-in is caused by a natural degradation of the amount of light output the phosphor chemicals emit as they continue to be “excited” over time, and translates to a “ghost image” when the same image is displayed in the same location for a prolonged period. When a static image like this is displayed, pixels that were “on 100%” (displaying white) would be degrading at the maximum rate while pixels that were “turned off” (displaying black) would not be degrading at all. Over time, after these two groups of pixels were displaying the same color, a noticeable variation in light output for the two groups occurs and the ghost image becomes recognizable.

For Digital Ad Board applications, this characteristic is not too problematic as long as the ad segments that comprise the ad loop represent sufficient variation over the cycle so as to approach a fully dynamic (random) presentation at each pixel of the display. In practice, this would translate to setting a maximum duty cycle of 1% or so for any given image (depending on the native characteristics of the particular plasma display used, the color gradation of the images, the frequency of changes of the ad loop itself, and whether any image spiraling techniques were used to reduce the native burn rate). The net result of a fully dynamic ad loop is that all pixels of the display would degrade roughly the same amount over time, and no ghost effect would be noticed.

For digital signage applications other than Digital Ad Boards (“General Purpose Digital Signage”) and “Converged TV” applications wherein the display is used for consumer TV as well as computer-based activities such as web browsing and word processing, the impact of burn-in is far more pronounced. In these applications, at least some portion of the display is not presenting a series of images or video; rather, it would generally include some fixed or pseudo-fixed images that would be present over an extended period of time. For example, as a Flight Information Display in an airport or as a Digital Menu Board in a quick service restaurant, there are generally fixed text fields and frequently fixed text that would be displayed; generating random location patterns is simply not practical in most cases. For these applications, the effect of burn-in becomes dramatic and, in many cases, would prevent the use of plasma technology. Furthermore, eliminating plasma display technology from consideration limits the use of digital displays at all in many of these applications since there are currently no other practical alternatives.

In order to reduce the rate of burn, some plasma manufacturers have incorporated electronics that periodically shifts the image around in a spiral or other pattern, usually within a 5 pixel radius. Although this technique reduces the rate of burn-in, it does not eliminate it; additionally, it introduces a noticeable and distracting movement of the screen image which is particularly noticeable when the user is reading text at the time of the movement.

In view of the foregoing, there remains a need in the art for enhanced display panels and associated apparatus and methodology for reducing or eliminating the burn-in problem.

### SUMMARY

According to one aspect of the invention, a visual display includes a display installation and a computer. The display installation may include a display panel having including a plurality of pixels (or subpixels containing individual color elements of the pixel; in this application the terms are used interchangeable and generally refer to the smallest addressable picture element of the display technology) each with a bit depth and an interface for receiving a video input and for driving the display panel. The computer is configured to determine a primary burn value for each of the pixels for a primary period of time, and to determine a secondary burn value for each of the pixels for a secondary period of time. The computer determines the secondary burn values such that when a pixel is driven at the secondary burn value thereof for the secondary period of time, an average value of the pixel for the primary and secondary periods of time is approximately equal to one-half of the bit depth of the pixel.

According to another aspect of the invention, a computer may control or operate a display panel by first determining a primary burn value for each of the pixels in the display panel during an active burn mode. The computer may then identify one of the pixels that has a low primary burn value, thereby indicating that the identified pixel has been burned at a greater degree than pixels having higher primary burn values. The computer may then determine a number of pixels that have primary burn values higher than the low primary burn value, thus indicating that these pixels have been burned at a lesser degree than the identified pixel with the low burn value. The computer may then cause the interface to drive the display panel during a reverse burn mode such that the pixels having a primary burn value higher than the low primary burn value of the identified pixel are burned to reduce the respective differences between higher primary burn values and the low primary burn value.

According to still another aspect of the invention, a computer may control a display panel by monitoring an image history of the pixels during an active burn mode and then identifying a pixel that has been burned at a greater degree than a number of other pixels. The computer may then determine a number of pixels that have been burned at a lesser degree than the identified pixel. The display panel may then be driven during a reverse burn mode such that the number of pixels that have been burned at a lesser degree are burned to reduce the burn difference between each of the number of pixels and the identified pixel.

According to still another aspect of the invention, application of the reverse burn mode can be initiated based on whether or not anyone is in the presence of the display, using any one of a number of available sensing technologies, which may include image recognition, thermal sensing, or other available means. Because of the fact that in certain applications, scheduling of the reverse burn mode via associated computer or On Screen Display at specific times might be problematic, the ability to sense when users are in view of the display to automatically turn the reverse burn mode on or off becomes useful.

Other features and advantages of the present invention will become apparent to those skilled in the art from a consideration of the following detailed description taken in conjunction with the accompanying drawings.

### BRIEF DESCRIPTION OF THE DRAWINGS

These and other features, aspects and advantages to the present invention will be more fully understood when considered with respect to the following specification, appended claims and accompanying drawings, wherein:

FIG. 1 is a block diagram illustrating a visual display of the invention;

FIG. 2 schematically illustrates pixels of a display panel;

FIG. 3 is a flow chart illustrating methodology according to a number of embodiments of the invention;

FIG. 4 is a block diagram of a network of display installations;

FIG. 5 illustrates a screen layout of an interactive display panel according to a number of embodiments;

FIG. 6 is a flow chart illustrating methodology for monitoring image history and generating reverse burn values according to some of the embodiments;

FIGS. 7A and 7B illustrates reverse burn methodology according to still other embodiments of the invention;

FIG. 8 illustrates a screen layout for an interactive display panel according to other embodiments;

FIG. 9 is a block diagram illustrating a display installation according to a number of embodiments;

FIG. 10 illustrates a display panel during redeployment of critical content according to some of the embodiments of the invention;

FIG. 11 illustrates methodology for operating a display panel according to a number of embodiments;

FIG. 12 illustrates methodology for operating a display panel according to other embodiments;

FIG. 13 is a perspective view of a visual network appliance of the invention;

FIG. 14 is a block diagram of the visual network appliance; and

FIG. 15 schematically illustrates an interactive digital ad board.

FIG. 16 schematically illustrates an embodiment of a multiple display panel architecture.

FIG. 17 is a block diagram illustrating a display installation according to a number of embodiments;

FIG. 18 is a block diagram illustrating a display installation according to a number of embodiments.

FIG. 19 illustrates typical phosphor luminosity degradation curves in relation to a number of embodiments.

FIG. 23 is a block diagram of a system according to one embodiment of the present invention, illustrating the basic structure of a Visual Network Appliance (“VNA”) system.

FIG. 24 is a block diagram of a system according to another embodiment of the present invention, illustrating the basic structure of an interactive Visual Network Appliance (“VNA”) system.

FIG. 25 is an illustration of a system according to another embodiment of the present invention.

FIG. 26 is an illustration of a system according to another embodiment of the present invention.

### DETAILED DESCRIPTION

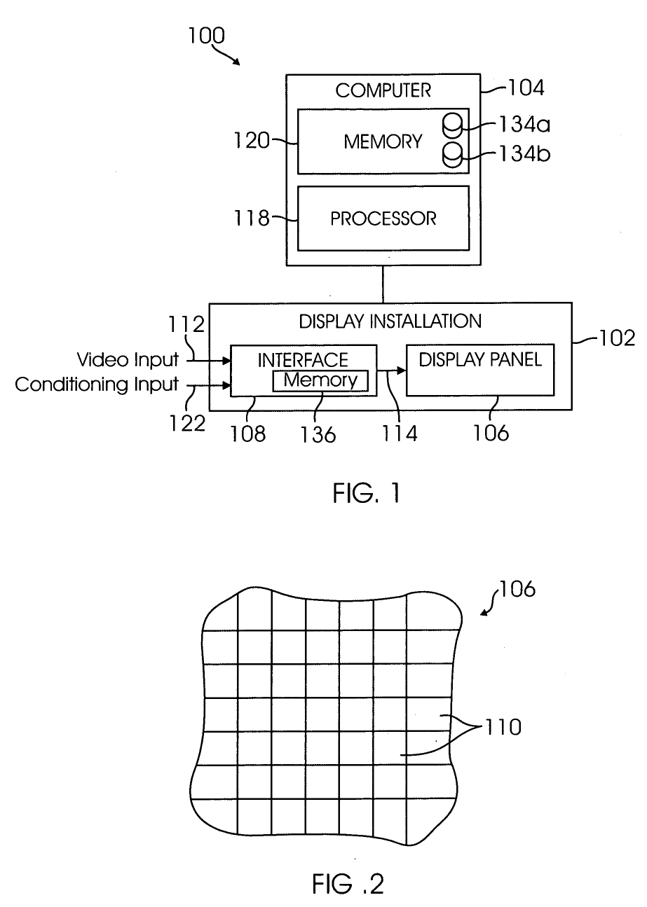

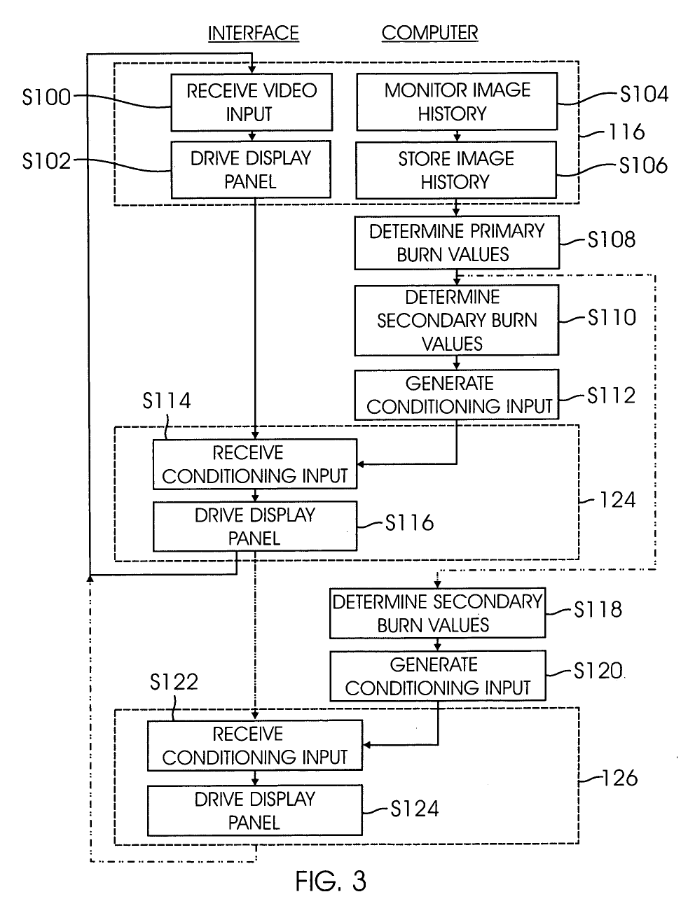

Referring to the drawings in more detail, a visual display 100 of the invention is illustrated in FIG. 1. According to a number of embodiments, the visual display 100 may include a display installation 102 and a computer 104. The display installation 102 may include a display panel 106 and an interface 108 in communication with the panel 106. The display panel 106, which in some of the embodiments includes a plasma display panel, has a matrix or a plurality of pixels 110 as represented in FIG. 2. With additional reference to FIG. 3, the interface 108 receives a video input 112 (S100) and responsively drives the display panel 106 (S102) with a drive signal 114.

According to a number of embodiments, the computer 104 is configured to condition of display panel 106 in response to the video input 112. This panel conditioning feature of the invention mitigates uneven burn-in of the pictures where the display panel 106 is not used in an ideal dynamic mode in which all of the pixels are burned at the same rate and intensity. For example and with additional reference to FIG. 3, in some of the embodiments, during a primary period of time ΔT₁, the computer 104 may monitor an image history (S104) of the pixels 110.

For the purposes of this description, the primary period of time ΔT₁ may be defined as a period of time during which the interface 108 is driving the panel 106 to display a desired or a predetermined video input 112, such as a sequence of advertising images or a sequence of images resulting from an interactive selection (which will be discussed in more detail below). Also for the purposes of this description, the display installation 102 may be described as operating in an active burn mode during the primary period of time ΔT₁ which is indicated by reference numeral 116 in FIG. 3. In addition, each pixel (or picture element) 110 has a bit depth that equals 2^{N} where N is the number of bits (e.g., 8 or 10) and a specific set of spatial coordinates within the panel 106 that uniquely identifies the pixel.

Further, for the purposes of this description, the image history may include data indicative of the color and the intensity of each pixel 110 during the active burn mode 116 of the panel 106. For example, in embodiments in which each of the pixels 110 includes a color set having a plurality of color values each with a bit depth, e.g., red-green-blue (RGB) color values each ranging from 0 to 255, the image history may include data indicative of the each set of color values driving each of the pixels 110. More specifically, the drive signal 114 may include a drive value for each pixel 110, with the drive value including a value for each of the color values, e.g., 128-128-128 for gray, 255-0-0 for red, or 0-0-0 for white. During the active burn mode 116, the interface 108 may drive the display panel 106 such that each of the pixels 10 is driven at a plurality of drive values.

The computer 104, which may include a processor 118 and a memory 120, may then store the image history in a database in the memory 120 (S106). Based on the image history, the computer 104 may then determine a primary burn value B₁ (S108) for each of the pixels 10 during the active burn mode 116 (i.e., during the primary period of time ΔT₁). In a number of embodiments, the primary burn value B₁ for a pixel 110 may be an average value of the pixel during the active burn mode 116.

The computer 104 may then determine a secondary burn value B₂ (S110) for each of the pixels 110. The secondary burn value B₁ is calculated to complement or even out the burn-in effects the primary burn value B₁ had on a respective pixel 110. For example, in a number of embodiments, the second burn value B₂ is determined such that when a pixel 110 is driven at the secondary burn value B₂ for a secondary period of time ΔT₂, an average value of the pixel for the primary period of time ΔT₁ (i.e., the active burn mode 116) and secondary period of time ΔT₂ is approximately equal to one-half of the bit depth of the pixel, that is:
(B₁+B₂)÷2=2^{N}÷2, or
B₁+B₂=2^{N},
where: B₁ is the primary burn value of a pixel; B₂ is the secondary burn value of the pixel; and 2^{N} is the bit depth of the pixel.

Accordingly, in some of the embodiments, the computer 104 may calculate the secondary burn value B₂ of each pixel to be the difference of the bit depth and the primary burn value, namely:
B₂=2^{N}−B₁.

Based on the secondary burn values B₂ of the pixels 110, the computer 104 may then generate a conditioning input 122 (S112) and provide the conditioning input 122 to the interface 108. Upon receiving the conditioning input 122 (S114), the interface 108 may then drive the panel display 106 for the secondary period of time ΔT₂. For the purposes of this description, the display installation 102 may be described as operating in a reverse burn mode during the secondary period of time ΔT₂, which is indicated by reference numeral 124 in FIG. 3.

During the reverse burn mode 124, the interface 108 generates the drive signal 114 responsive to the conditioning input 122. After driving the display panel 106 during the reverse burn mode 124 (i.e., for the secondary period of time ΔT₂), the interface 108 may then return to the active burn mode 116 and receive another video input 112 (S100). Also during the reverse burn mode 124, the interface 108 drives the display panel 106 to counteract burn-in of pixels 110 during the active burn mode 116 so that each of the pixels 110 degrades or burns out at the same rate, thereby reducing or substantially eliminating ghosts in subsequent active burn modes 116.

For example, in embodiments where each pixel 110 has a RGB color set with a bit depth of 256, if the primary burn value B₁ of a pixel 110 is 0-0-0 for a primary period of time ΔT₁ of 8 hours, then the secondary burn value B₂ of the pixel may be 255-255-255 for a secondary period of time ΔT₂ of 8 hours, such that the average value of the pixel for a full duty cycle ΔT₁+ΔT₂ (i.e., during the active and reverse burn modes 116 and 124) is 128-128-128, wherein the primary and secondary periods of time are approximately equal. Alternatively, if the primary burn value B₁ of a pixel 110 is 0-0-0 for a primary period of time ΔT₁ of 8 hours, then the secondary burn value B₂ of the pixel may be 234-234-234 for a secondary period of time ΔT₂ of 16 hours, such that the average value of the pixel for a full duty cycle ΔT₁+ΔT₂ is still 128-128-128.

In a number of embodiments, the computer 104 may include software stored in memory 120 for use by the processor 118 to carry out the foregoing functionality of the visual display 100. In other embodiments, the computer 104 may be a single-board computer with a graphics card connected to the interface 108.

In still other embodiments, the computer 104 may determine a plurality of secondary burn values B₂(1), B₂(2), B₂(3), . . . , B₂(n) for each of the pixels 110 such that when a pixel is driven at the secondary burn values B₂ for a corresponding plurality of secondary periods of time ΔT₂(1), ΔT₂(2), ΔT₂(3), . . . , ΔT₂(n), an average value of the pixel for the primary and secondary periods of time ΔT₁+{ΣΔT₂(i) [where i=1 to n]} is approximately equal to one-half of the bit depth. For example, as shown in FIG. 3, the computer 104 may determine a second set of secondary burn values B₂ (S118). Based on this second set of secondary burn values, the computer 104 may generate a corresponding conditioning input (S120) and provide this second conditioning input 122 to the interface 108. Upon receipt (S122), the interface 108 may drive the display panel 106 for a subsequent secondary period of time ΔT₂(2), or a subsequent reverse burn mode 126.

The cumulative effect of the plurality of reverse burn modes 124, 126 causes the pixels 110 to have a weight average value of one-half of the bit depth which, in an 8-bit embodiment, is 128-128-128. For example, for a RGB display panel, the interface 108 may drive the panel 106 at a duty cycle of 50% (100-200-150)+25% (152-100-100)+25% (160-12-112), where X %=the duty cycle.

According to a number of embodiments, a visual display 100 may include a plurality of display installations 102 in communication with the computer 104, for example, via a network 128 such as shown in FIG. 4. In this embodiment, the computer 104 may monitor the image history of each of the display panels 106 independently and responsively condition the panels 106 with respective conditioning inputs.

Regarding the monitoring of the image history (S104), the computer 104 may monitor the drive signal 114 from the interface 108 to the panel display 106. For example, an instantaneous measurement of the drive signal 114 at a given time may be made, with the resulting data stored in the memory 120. In addition, the drive signal 114 may be sampled at a predetermined frequency (e.g., once a second) with the resulting data stored in memory 120.

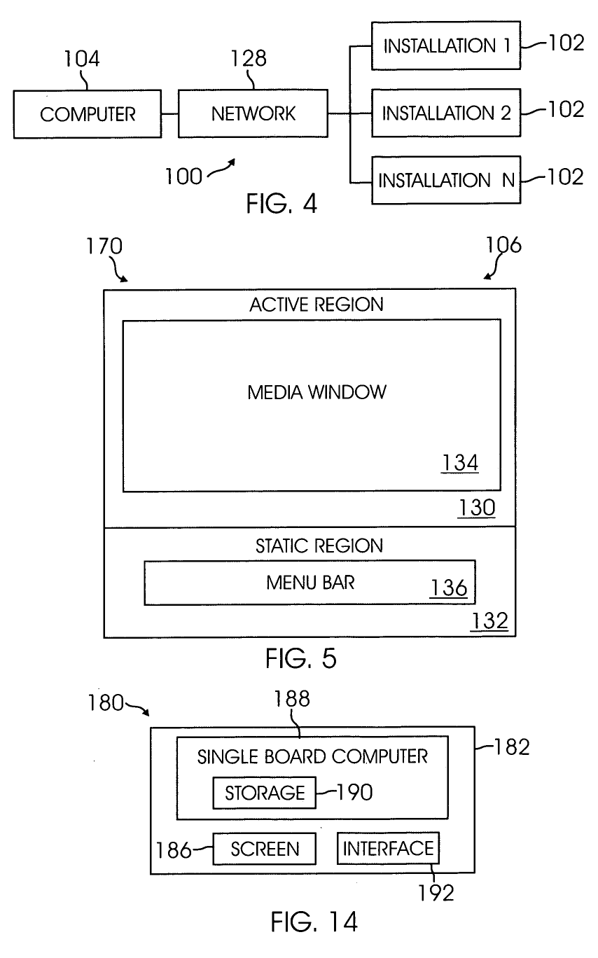

With reference to FIG. 5, in still other embodiments, the computer 104 may identify or determine one or more dynamic regions 130 of the display panel 106 and one or more static regions 132 of the panel 106. In this embodiment, the computer 104 may assume that the pixels 110 in the dynamic region 130 operate in a full dynamic range such that the burn-in rate for each of the pixels is approximately the same. Accordingly, the computer 104 may not condition the pixels 110 in the dynamic region 130. On the other hand, the computer 104 may assume that the pixels 110 in the static region 132 operate at a single level during the active burn mode 124, i.e., the primary burn values B₁ are generally constant. Accordingly, the computer 104 may implement a reverse burn mode 126 with complementary secondary burn values B₂ (e.g., 2^{N}−B₁) on a 50% duty cycle. In other embodiments in which the display installation 102 is a public interactive display, the active burn mode 124 may be during regular business hours, while the reverse burn mode 126 may be during “off” hours or when the business is closed (e.g., at night) so as not to interrupt regular operations for panel conditioning.

With continued reference to FIG. 5, display panel 106 may include an interactive plasma display panel (PDP) in which the dynamic region 130 includes a media window 134 and the static region 132 includes a menu bar 136. Accordingly, upon user selection at the menu bar 136, the interface 108 provides a drive signal 114 that displays desired content (e.g., images, graphics, text, etc.) in the media window 134. In some of the embodiments, the media window 134 may displays a “film loop” to allow user navigation. Additionally, the menu bar 136 may display text or icons in fixed or variable positions or messages to call attention to the user that on-demand interactive content is available. This interactive embodiment will be discussed in more detail below.

When the display installation 102 is in normal use during the active burn mode 124, the image-history monitoring process may continue. When the display installation 102 is in the reverse burn mode 126, the data of the image-history database in the memory 120 may be used to determine which of the pixels 110 need to display which colors and for how long in order to effectively reverse or counteract the burn-in effect that has occurred during the active burn mode 124.

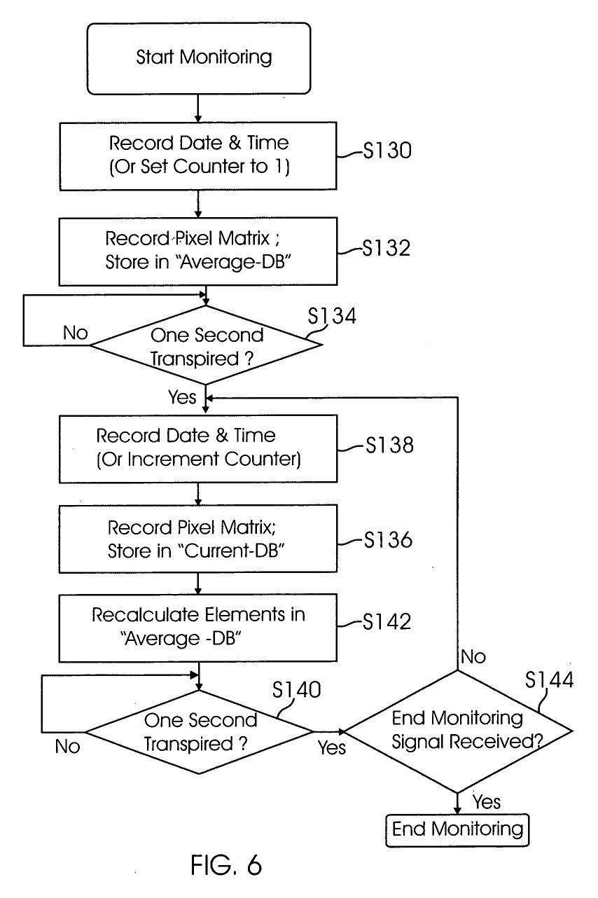

One example of the monitoring process is illustrated in FIG. 6. According to this embodiment, two databases 134a and 134b (see FIG. 1) may be used, each with n elements, where n is the total number of pixels 110 on the display panel 106. The first database 134a may be is called an “Average-DB,” and the second database 134b may be called a “Current-DB.” In addition, the interface 108 may include a display memory 136 in which a pixel matrix is stored. The pixel matrix includes the RGB values of each of the pixels 110 at any given time. Accordingly, the databases 134 may have a structure with n records each with three fields to respectively hold the red, green, and blue color values (e.g., which may be represented by an integer from 0 to 255 for 8-bit embodiments).

Prior to the start of the monitoring process, each database 134 may be set to “empty,” i.e., all n values are set to 0, and a counter variable is set to 1 (S130). Alternatively, the date and time may be recorded. At the start of the monitoring process, the computer 104 may record the pixel matrix of the display memory 136 into the first database 134a (S132); accordingly, Average-DB is populated with the RGB values from the display memory 136 at that point in time. After a predetermined amount of time, e.g., one second (S134), the computer 104 may record the display memory 136 and store this data in the second database 134b (S136), i.e., Current-DB, with the counter being incremented by 1 (or, alternatively, the current date and time being recorded) (S138).

During the next cycle period, for example, one second (S140), the contents of Average-DB may be re-calculated (S142). For example, for each color field of each record in Average-DB, the corresponding field in Current-DB and the counter may be used to modify each field in Average-DB according to the formula:
NAF={[OAF*(C−1)]+CF}/C,
where: NAF is the New value of Average-DB Field; OAF is the Old value of Average-DB Field; CF is the Value of Current-DB Field; and C is the Counter value.

Accordingly, this procedure generates an ongoing weighted average for each of the three color components for each pixel 110 of the display panel 106 until an end monitoring signal is received (S144).

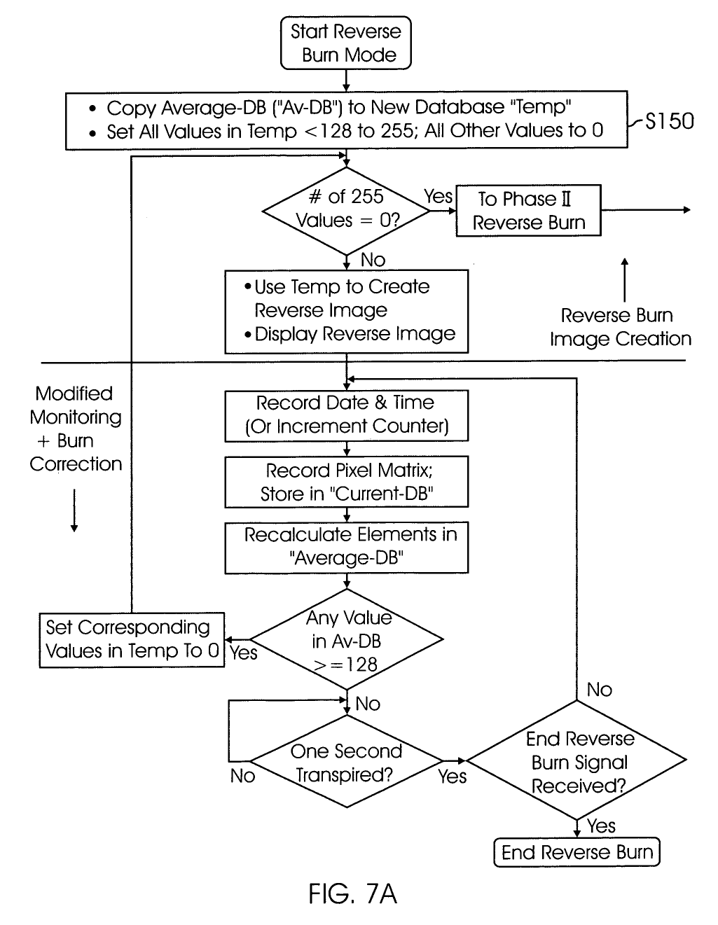

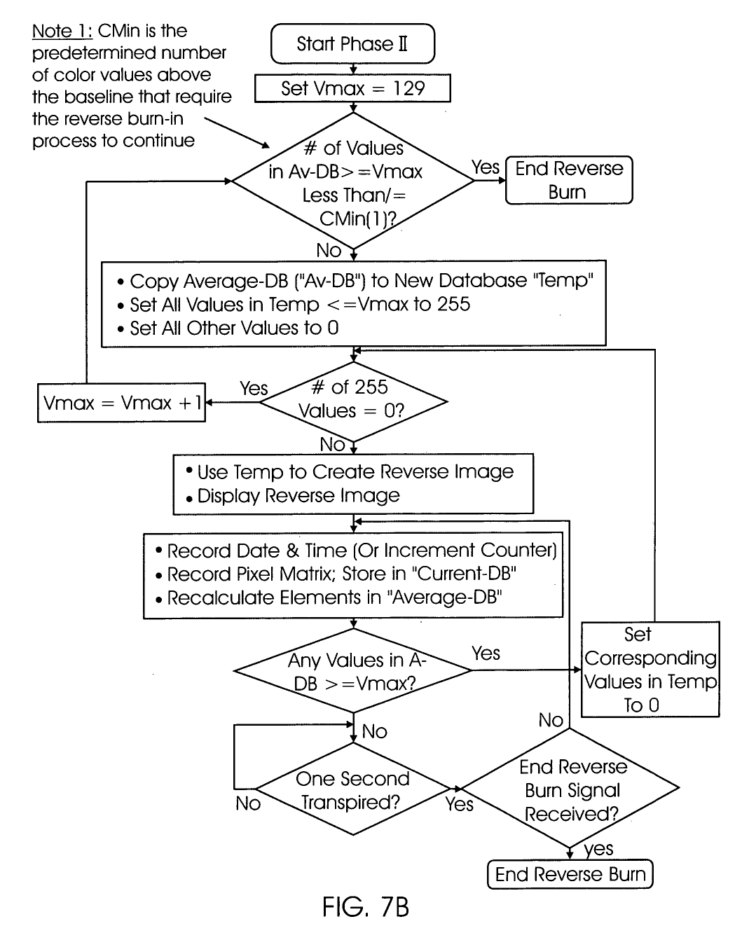

As shown in FIGS. 7A and 7B, when the visual display 100 initiates a reverse burn mode 126, a similar process may be used, except that the image being displayed responsive to the conditioning input 122 is now generated by the computer 104 with the intent to move each pixel 110 towards the one-half bit depth average (e.g., 128-128-128). One example of accomplishing this is to set all of the color values of the pixels 110 whose value in Current-DB is less than 2^{N}/2 to 2^{N}−1 (e.g., 128 to 255), and to set all of the other color values of the pixels to 0 (S150). To ensure that a pixel 110 is not burned past 2^{N}/2 (e.g., 128), the computer 104 may re-check the new Current-DB field for the pixel during each cycle prior to re-setting the field to 2^{N}−l (e.g., 255). According to this methodology, the brightest pixels in the display panel 106 are systematically brought back to a median color image (e.g., 128-128-128) over the full duty cycle.

It is possible that after running the reverse burn process for a period of time, all of the fields of Average-DB are not less than 128, at which point the reverse burn mode 126 may stop. However, some of the field values may now be significantly higher than 128 (indicating a dark spot on the display panel 106). These higher values may then be continued in the reverse burn mode 126. Applying 255 to all of the fields that are now at 128 may gradually increase so that entire set towards the peak value. In this case, care would need to be exercised to ensure that the entire display panel 106 is not unnecessarily run in the reverse burn mode 126 (hence shortening the life expectancy thereof) to bring all fields in sync with a small group of pixels.

In embodiments in which the display panel 106 includes a plasma display panel (PDP), different manufacturers utilize plasma crystals whose burn rate differs between red, green, and blue components. Additionally, some manufacturer's electronics dynamically modify the light intensity of displayed pixels depending on the total light output being displayed. In both cases, the computer 104 may accordingly modify or adjust the weighting of the reverse burn values B₂ or the conditioning input 122 to take into account these manufacturing variances.

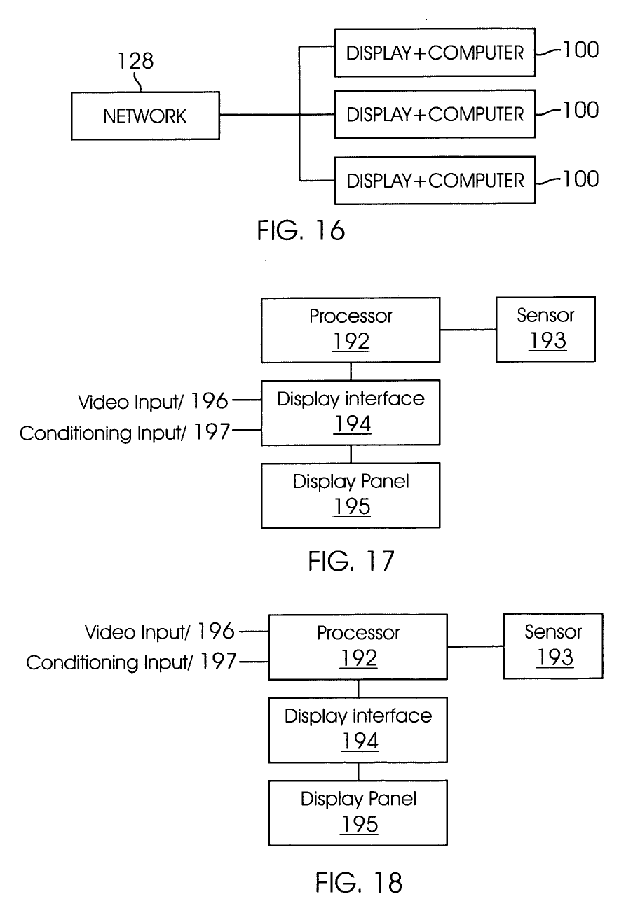

According to a number of embodiments, the display panel 106 may include a combination of critical and non-critical content (such as promotional and menu items in a digital menu board application) as illustrated in FIG. 10. In multiple display panel configurations as illustrated in FIG. 16, wherein each display panel 106 may contain critical and non-critical content, the computers 104 can be configured to display critical content normally shown on other displays in the event of a hardware failure affecting one or more of the other displays. In networked embodiments as shown in FIG. 4, the computer 104 may control the operation of a plurality of the display panels 106. Accordingly, the computer 104 may control critical content as well as non-critical promotional content. Further, the computer 104 may be configured to display all critical content on a single display panel 106, or a number of display panels 106 that is less than the total number N of display installations 102.

In addition, in the event of a hardware failure of one of the display installations (1, 2, . . . , N) 102, the computer 104 may redeploy critical content onto the display panel 106 of a surviving display installation 102. The computer 104 may utilize a standard interface mode and alternate interface mode(s) in conjunction with peer-to-peer polling mechanisms to trigger the redeployment event.

With continued reference to FIGS. 1 and 4, to identify the failure of one or more display panels 106, according to some of the embodiments, the computer 104 controls and monitors each display installation 106 remotely through the network 128, such as a wide area network (WAN). If there is a hardware failure during a period of no WAN connection, then the computer 104 may not be capable of automated recovery and redeployment of critical content. Accordingly, a peer-to-peer polling system may be implemented.

In this embodiment, each of the display installations 102 may include a computer 150, an interface 152, and a display panel 154 as shown in FIG. 9. Each computer 150 in the array of installations 102 may then periodically try to establish contact with one or all of the other computers 150. In the event that contact cannot be established, then the computer 150 assumes that the installation 102 with which contact cannot be established has experienced a hardware failure. Accordingly, the computer 104 may then trigger an appropriate alternate layout and redeployment of critical content from the nonfunctional display installation 102.

In other embodiments, the computer 104 may automatically change a display layout of one of the display panels of one of the functioning installations 102 to include the critical content of the nonfunctioning installation. For example, with reference to FIG. 10, the display layout of a functioning panel 106 includes noncritical content 160 and critical content 162. When critical content from a nonfunctioning panel is redeployed to the functioning panel 106, then the computer 104 may reduce or eliminate the noncritical content 160 and add critical content 164 from the nonfunctioning display.

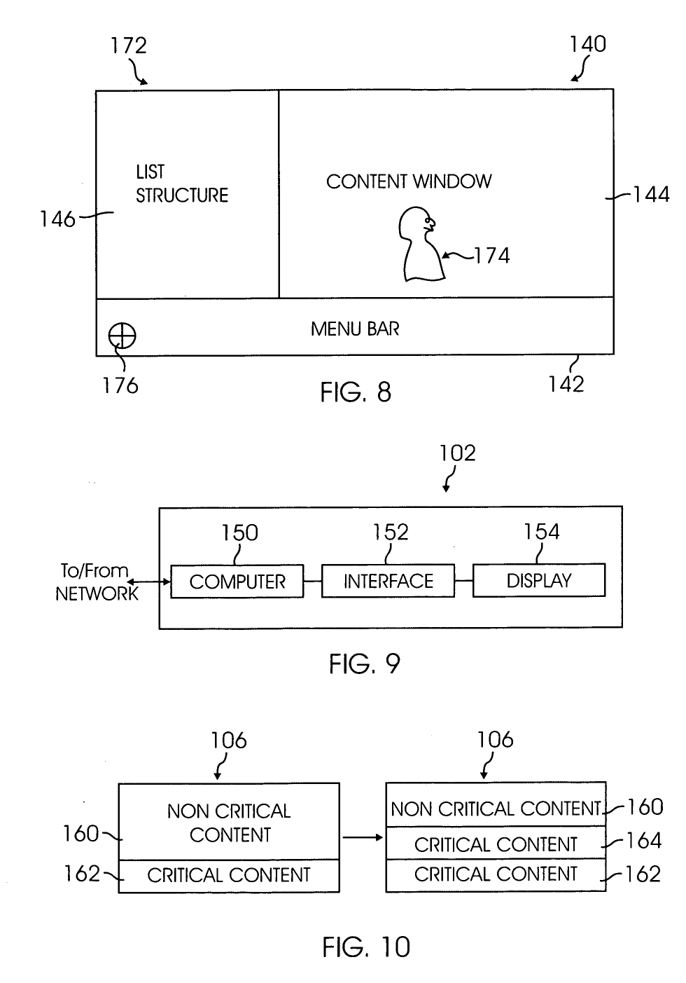

As mentioned above, according to a number of embodiments, the display panel 106 may include an interactive display panel 140, an example of which is illustrated in FIG. 8. The interactive display panel 140 may include a menu bar 142, a content window 144, and a list structure 146. With further reference to FIG. 8, the three-part partition of the display panel 140 including the menu bar 142, the content window 144, and the list structure 146 may be used in the Default Screen in a number of embodiments. Accordingly, throughout a decision tree sequence, the same three-partition format may be used to reduce confusion for the user and lead to simpler navigation. In wayfinding applications, the content window 144 may display animated maps that visually maps out a path from the current location of the use to the selected location, thereby significantly enhancing the wayfinding functionality of the panel 140.

According to still other embodiments, navigation may be further enhanced by introducing feedback/guidance mechanisms throughout navigation of the decision tree. For example, the computer 104 may employ audio and/or visual indicators to reinforce the current location in the decision tree and guide the user on to the next step in the process. In addition, the computer 104 may utilize the content window 144 to display “next step” visual prompts (that is, “Visual Navigation Enhancement,” elements or VNE) in conjunction with relevant audio prompts to guide the user. Categories of VNE elements can be stored and called by the user interface depending on the type of information being displayed and where the user is located within the decision tree structure. For example, a generic “select a store from the list” audio prompt may be one such audio prompt that may coincide with a VNE element. In further embodiments, the VNE element may include a computer animated figure that virtually guides the user on to the next step.

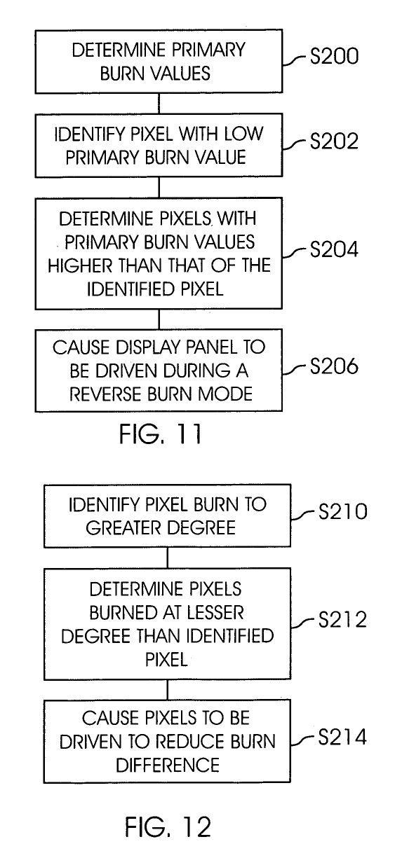

With reference to FIG. 11, in other embodiments, the computer 104 may control or operate a display panel 106 by first determining a primary burn value B₁ for each of the pixels 110 for the active burn mode 116 (S200). The computer 104 may then identify one of the pixels 110 that has a low primary burn value B₁ (S202). A pixel 110 having a low primary burn value, e.g., 10-20-10 in an 8-bit embodiment, indicates that the pixel 110 has been burned at a greater degree than pixels having a higher primary burn value, e.g., 180-200-230. The computer 104 may then determine a number of pixels 110 that have primary burn values B₁ higher than the low primary burn value (S204), thus indicating that these pixels have been burned at a lesser degree than the identified pixel with the low burn value. The computer 104 may then cause the interface 108 to drive the display panel 106 during a reverse burn mode (S206) such that the pixels having a primary burn value B₁ higher than the low primary burn value of the identified pixel are burned to reduce the respective differences between higher primary burn values and the low primary burn value.

According to a number of embodiments, the low primary burn value B₁ of the identified pixel may be the lowest value of the primary burn values B₁ determined by the computer 104, such that the identified pixel has been burned at the greatest degree out of any of the pixels 110 of the display panel 106 during the active burn mode 116. For the purposes of this description, the term “burn” indicates to activate, operate, or drive a pixel with a drive value or a plurality of drive values for a period of time. In color applications, the drive value may include a plurality of color values (e.g., RGB).

In addition, each of the pixels 110 has a difference between the primary burn value B₁ thereof and the low primary burn value B₁ of the identified pixel 110. The computer 104 may then cause the interface to drive the display panel 106 during the reverse burn mode 124 such that each of the pixels 110 is burned to reduce the difference between the primary burn value thereof and the low primary burn value of the identified pixel.

Referring to FIG. 12, in still other embodiments the computer 104 may control the display panel 106 by monitoring an image history of the pixels 110 during the active burn mode 116 and then identifying a pixel 110 that has been burned at a greater degree than a number of other pixels (S210). The computer 104 may then determine a number of pixels that have been burned at a lesser degree than the identified pixel (S212). The computer 104 may then causing the display panel 106 to be driven during the reverse burn mode 124 such that the number of pixels that have been burned at a lesser degree are burned to reduce the burn difference between each of the number of pixels and the identified pixel (S214). The burn difference may be defined as the difference in magnitude of the primary burn values between the identified pixel and the other pixels 110 of the panel 106.

With further reference to FIG. 1, according to a number of embodiments, a burn-in recovery system of the invention includes the computer 104 and an image monitoring software program stored in the memory 120. The software program maintains ongoing image history and uses the image history to generate new images for presentation on the display panel 106 which reverse the burn-in process. The computer 104 may generate reverse burn images programmatically so that the reverse burn image is continuously modified based on the current ongoing image history.

With further reference to FIGS. 5 and 8, according to a number of embodiments, a zero-burn user interface 170 (FIG. 5) and 172 (FIG. 8) for a display panel 106 and 140 is illustrated, such as a plasma display panel. The display panels 106 and 140 are susceptible to burn-in of static and pseudo-static images. As mentioned above, user interfaces 170 include a static or pseudo-static area 132, and user interface 172 includes a static or pseudo-static area 142. The user interface 170, 172 utilizes dynamic color sets having a weighted average of 128-128-128 in static areas 132, 142. The weighted average may be based on duty cycle, variations in color burn rates, modifications of color or intensity by display electronics prior to rendering on the display, or any combination thereof.

With particular reference to FIG. 5, according to other embodiments, the interactive user interface 170 may include Default Screen that includes only the media window 134 and the menu bar 136. In some of the embodiments, the media window 134 may make up at least 75% of the surface area of the display panel 106. In these embodiments, the display panel 106 may be used as a public information system, for example, in a commercial building.

With particular reference to FIG. 8, the interactive user interface 172 may include a Content Screen that includes only the menu bar 142, the content window 144, and the list structure 146. In some of these embodiments, the content window 144 may make up at least 75% of the surface area of the display panel 140. These embodiments of the invention may be implemented as a public information system, for example, in a commercial building. In other embodiments, the Content Screen of the interactive user interface 172 may be used to display animated wayfinding maps.

As mentioned above, the interactive user interface 172 may utilize the Content Screen to display visual navigation enhancement (VNE) during decision tree navigation. For example, the visual navigation enhancement may be accomplished via a 3D virtual guide 174. The user interface 172 may include a speaker 176 so that may the virtual guide 174 may include audio coupled to animated speech. In addition, the 3D virtual guide may speak in multiple languages. In these embodiments, the speech may be generated by text-to-speech software. These embodiments may also be implemented as public information systems.

Referencing FIGS. 1 and 4, the computer 104 may be configured to perform fault-tolerant control of the display panel 106 of a plurality of display installations 102. As mentioned above, the fault-tolerant multiple-display architecture of the invention automatically redeploys critical content onto adjacent surviving display panels 106 using peer-to-peer polling to trigger the conversion or redeployment. In these embodiments, the visual display 100 may be implemented as a Digital Menu Board, for example, in a restaurant.

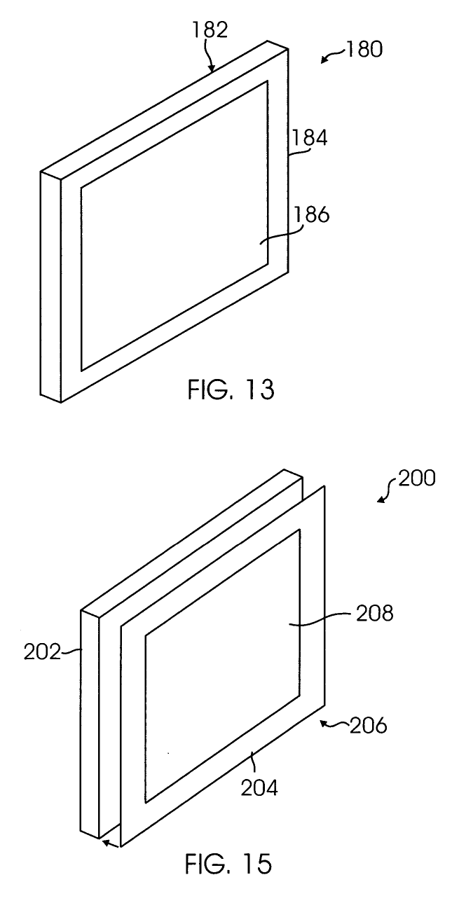

With reference to FIGS. 13 and 14, a visual network appliance 180 for use in digital menu board applications may include a thin, self-contained display unit 182 including a housing 184 characterized by a length, a width, and a depth. The visual network appliance 180 may include a large-format video display screen 186 and a single board computer 188 including a large-capacity mass data storage unit 190. In a number of embodiments, the single board computer 188 is contained within the housing 184. The appliance 180 may also include a network communications interface 192. According to some of the embodiments, a display image may be transferred from the storage 190 of the single board computer 188 directly to the screen 186 in digital format without first being converted to an analog signal.

Referencing FIG. 15, a large-format interactive digital ad board 200 of the invention may include a large-format video display screen 202 and a touch panel 204 dimensioned to fit over the video display screen. In addition, a user interface 206 includes a Default Screen that includes predominantly a media window 208. Accordingly, on-demand information may be made available on the display screen 202 upon request of a user by a user accessing the ad board 200 through the touch panel 204.

With particular reference to FIG. 17, according to other embodiments, the sensor 193 may be added to the visual display 100 (or physically outside of visual display system 100 with an input into to visual display 100). Such sensor is designed to identify if any individuals are in the vicinity of the display panel 195, or preferably if they are in direct view of the display panel 195; such sensing could be accomplished by image recognition, thermal recognition, or other available technologies. In these embodiments, the processor 192 is used in conjunction with the sensor 193 to switch between normal video 196 (also referred to as the “active burn mode” 116) and conditioning video 197 (also referred to as the “reverse burn mode” 124 as shown in FIG. 12). In typical operation the Processor 192 would be sending the normal video 196 to the display panel 195 when the sensor 193 detected the presence of an individual in view of the display panel 195. When the sensor 193 indicated to the Processor 192 an absence of any individual in view of the display panel 195, the Processor 192 would switch the video signal to the conditioning video 196 and begin the reverse burn-in mode (normalization of luminosity across all pixels in the display panel 195). These two input signals (normal video 196 and conditioning video 197) could be located at the display interface 194 (as shown in FIG. 17) or at the processor 192 section (as shown in FIG. 18). The display panel 195 can be made up of any type of light-emitting display technology which exhibits image degradation due to uneven usage of the display color-generating elements (“pixels”), whether due to luminosity degradation of phosphor elements or other image sticking mechanisms as are currently exhibited in liquid crystal display membranes. If the image degradation is caused by non-uniform usage of the color-generating elements of the display, the reverse burn mode 124 (FIG. 12) will likely have a beneficial effect at worst, or a complete recovery of the optimal image quality at best.

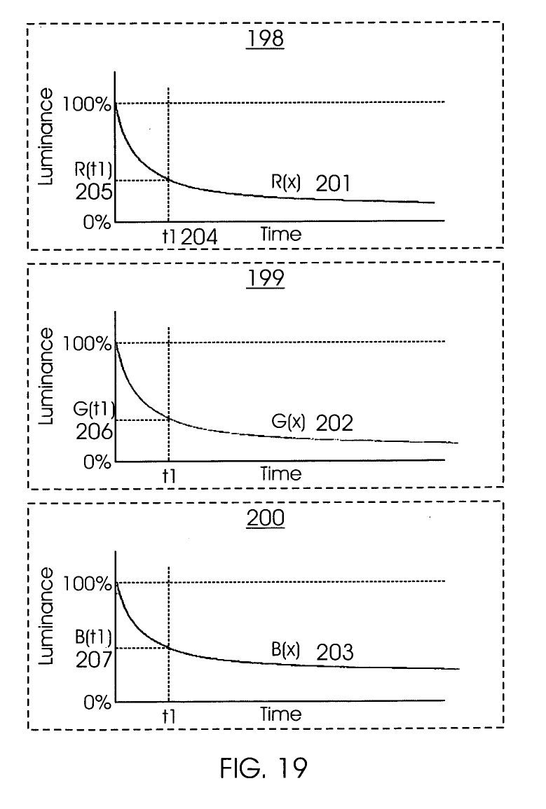

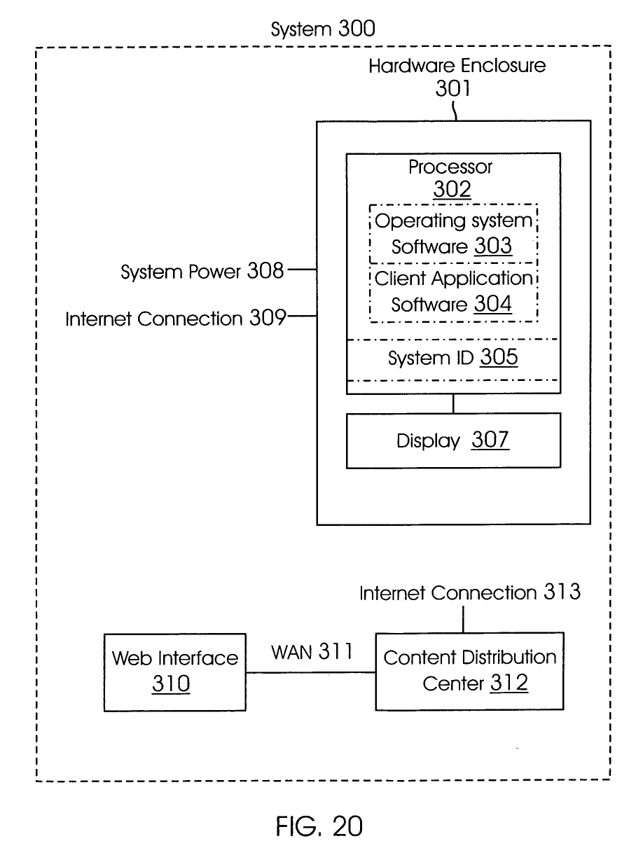

As indicated previously, the color and the intensity of each pixel 110 during the active burn mode 116 of the panel 106 can be represented by a number between 0 and 2^{N} for each of the colors in the color set, where N is the bit depth. Furthermore, it is assumed that this bit depth is representative of the full range of luminosity that the panel 106 is capable of displaying at each of the “sub-pixels” (one sub-pixel for each color in the color set that comprises the pixel 110). With particular reference to FIG. 19, each sub-pixel has associated with it a known degradation in luminosity over time, which is a physical property of the phosphors. Graphs 198, 199, and 200 are examples of typical luminosity curves R(x) 201, G(x) 202, and B(x) 203 over cumulative time of operation at full bit depth. At a particular time t1, which represents the cumulative time that a given sub-pixel has been operated at full bit depth (e.g., 255 in an 8-bit depth embodiment), each of these sub-pixels would have degraded to luminosity levels of R(t1) 205, G(t1) 206, and B(t1) 207 respectively. If any of these sub-pixels had been operated at somewhat less than full bit depth for the period t1, then they would be proportionately “further back” on the luminosity curve. For example, if the sub-pixel represented by R(x) 201 had operated at an average of 128 bit depth over time t1 (in an 8-bit depth embodiment), then the luminosity of the sub-pixel would be represented by R(t1/2).

With further reference to FIG. 19, in still other embodiments the computer 104 may monitor an image history of each sub-pixel of the pixels 110 in the display panel 106 during the active burn mode 116. By combining the image history with the luminosity curve information R(x) 201, G(x) 202, and B(x) 203, the percentage degradation in luminosity from the initial value can be determined for each sub-pixel and stored in a database 134. This database 134 can then be used to restore the display panel 106 to a uniform luminosity degradation level by having the computer 104 cause the display panel 106 to be driven during the reverse burn mode 124 such that the higher luminosity sub-pixels are operated while the lower luminosity sub-pixels are not, thereby reducing the variation in luminosity degradation to the eventual point of uniformity.

In still other embodiments the computer 104 may monitor an image history of each sub-pixel of the pixels 110 in the display panel 106 during the active burn mode 116 and dynamically modify the bit depth of the sub-pixel during the active burn mode in order to compensate for the variation in luminosity degradation. For example, with further reference to FIG. 19, assume that each of the three sub-pixels represented by graphs R(x) 201, G(x) 202, and B(x) 203 were operated at an average bit depth of 255 during the time t1 204, and that there associated luminosity for R(t1), G(t1), and B(t1) was therefore 90%, 80%, and 70% respectively. If at a given point in time the color of the pixel 110 during active burn mode was intended to be 128-128-128 (RGB), the actual color of the pixel 110 displayed on the panel 106 would look more like 128-114-100 due to the variations in luminosity degradation.

With reference to FIG. 1 and in accordance with this other embodiment, the video signal 112 would be modified by the interface 108 in accordance with the database 134 information to compensate for the variation in luminosity degradation by either increasing certain sub-pixels bit depth or decreasing the bit depth of others, or both. In the example mentioned above, the 128-114-110 actual color of the pixel 110 could be modified to 128-128-128 color of the pixel 110 displayed on the panel 106 by changing the video signal 112 for that pixel 110 to 128-144-165.

The burn compensation methodology described in this embodiment could also be used in combination with any of the display conditioning methods described previously, and also in conjunction with sensor recognition methodologies described herein to deliver the optimal display image management technique for a given display usage application and environment.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

As described previously in the present application, prior art implementations for Digital Signage systems required integration of disparate hardware and software components, customized configuration of system components, and specialized resources for site preparation and on-site system configuration. All of these elements increase the total cost of deploying the Digital Signage systems.

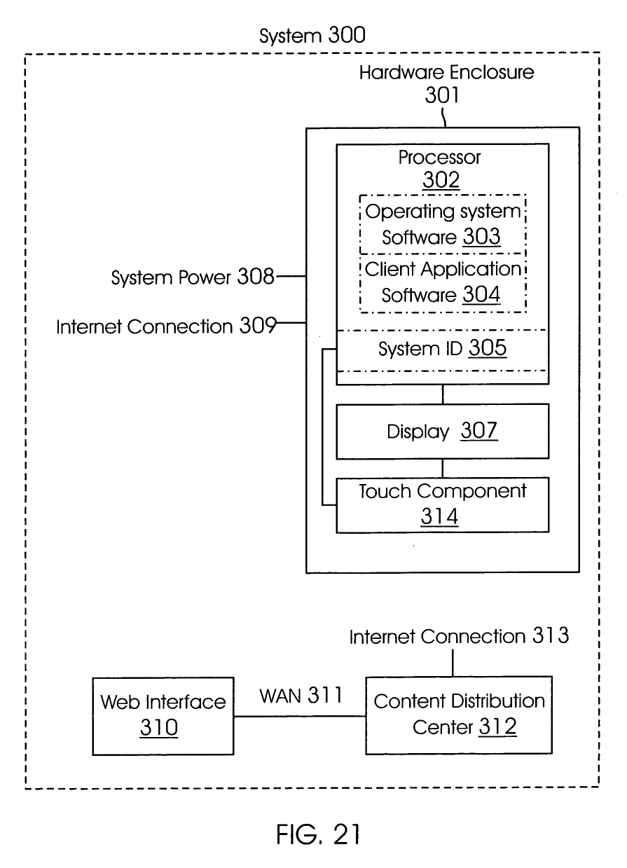

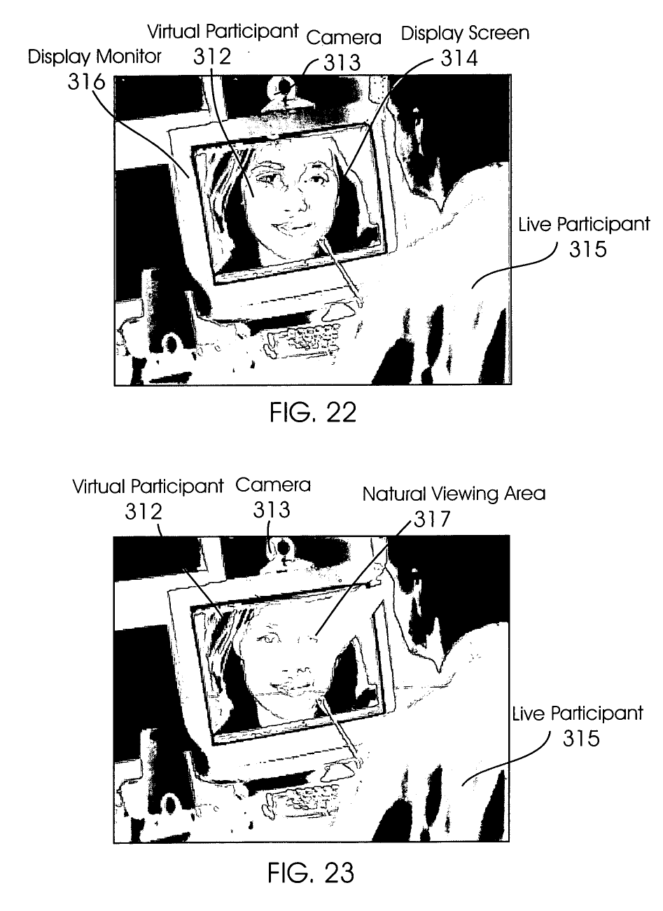

FIG. 23 illustrates the structure of a Visual Network Appliance (“VNA”) system designed for “plug-and-play” configuration and operation. The System 300 offers the lowest possible cost of Digital Signage deployment by eliminating specialized Information Technology resources for the site preparation, installation, and configuration of the system. Once the site and content preparation work is completed, the System 300 can be fully operational within minutes.

Referring again to FIG. 23, the System 300 includes the hardware, software and web service elements as shown. The VNA hardware includes, in the simplest implementation, Processor 302 and Display 307 hardware components mounted into a single Hardware Enclosure 301. As would be understood by someone with ordinary skill in the art, the Processor 302 could be any number of computer motherboards or embedded computer boards, provided the system performance was suitable to run the necessary software the and electrical and mechanical specifications were appropriate for the System 300 design. The Display 307 could be any display technology, but would preferably be thin and flat (such as plasma or LCD). Other hardware and mechanical components are generally necessary to design a complete System 300, but these are either described herein or understood by someone with ordinary skill in the art.

Referring to FIG. 23, the System 300 software components include Operating System Software 303 and Client Application Software 304. The Operating System Software 303 could be any industry-standard OS such as Windows or Linux. In the preferred embodiment of the present invention, the Operating System Software 303 would be pre-configured prior to shipment to the Digital Signage Site (the physical location of the System 300), so that a known-good and well-optimized OS configuration can be used for optimal performance and stability. The Client Application Software 304 is an application-specific program designed to facilitate scheduling and displaying the Digital Signage content specific to the site. In the preferred embodiment of the present invention, the Client Application Software 304 precludes direct access by the user to the Operating System Software 303 thereby maintaining the integrity of the operating system and limiting the introduction of changes to the OS which could destabilize the system.

Also shown in FIG. 23 is a System ID 305, which is a unique identification code for the unit. This could be the MAC Address which is typically embedded into the CPU and made available to the OS, or some other unique identification code loaded into the Client Application Software 304 program. In the preferred embodiment of the present invention, the MAC address would be used so that the Client Application Software 304 program would be the same for all outgoing shipments to the various Digital Signage Sites; this allows for a more efficient standard product flow to be used rather than requiring any customization of software for a particular unit prior to shipment.

Referring to FIG. 23, the System 300 hardware enclosure includes System Power 308 connections for typical 120V AC power connections to the building, and an Internet Connection 309 with could be a wired Cat5 type patch cable connection to an RJ45 jack, or a wireless LAN transceiver embedded or attached to the System 300 hardware electronics. Although other types of connections could be made available, in the preferred embodiment of the present invention these two are the only ones required to facilitate complete operation of the System 300.

Also shown in FIG. 23 are other components separate from the Hardware Enclosure 301. These include the Web Interface 310, WAN 311, Content Distribution Center 312, and Internet Connection 313. These components represent the remote (and generally distributed) system components that facilitate converting the generic hardware and software located at the Digital Signage Site to the site-specific content and functionality. The Web Interface 310 is a computer running a standard Internet browser program like Microsoft's Internet Explorer, which facilitates communicating with the Content Distribution Center 312 over the Wide Area Network shown in the figure as WAN 311. The Content Distribution Center 312 is a server or group of servers which run software programs designed to store and distribute the site-specific content out to the appropriate Digital Signage Sites, and are connected to the Internet through the Internet Connection 313.

In a preferred embodiment of the present invention, the Web Interface 310 allows password-protected access by the designated Digital Signage system administrator to configure system variables and load or edit content for their own sign or signs. Typically prior to the physical installation of the System 300 hardware at the Digital Signage Site (although not necessarily required), the system administrator would prepare the Digital Signage configuration file on the Content Distribution Center 312 servers, which would in turn store the configuration file until the System 300 hardware was installed.

The Digital Signage Site preparation work consists of running AC power and data communications cables (or setting up a wireless network) and terminating them at the specified location for the Hardware Enclosure 301. Particularly in the case of wired data communications provisioning, this work is a standard construction process which utilize trades widely available to commercial property owners and/or managers. The only other required element for site preparation is to establish Internet access service to the facility, and to ensure the Internet connection is delivered to the Digital Signage Site. In a preferred embodiment of the present invention, the Internet connection uses an IP address dynamically assigned by the Internet Service Provider's network, and eliminates any additional network equipment (such as a firewall or router) which would obstruct public-side “visibility” of the Digital Signage Site location. This would allow someone with ordinary skill in the art to configure the Client Application Software 304 to automatically connect to the Content Distribution Center 312 without requiring site-specific IP addresses to be loaded into the system.

In a preferred embodiment of the present invention, the site preparation work is therefore limited to establishing valid power and Internet connections at the designated location for the Digital Signage Site. Once done, the Hardware Enclosure 301 is mounted and the System Power 308 and Internet Connection 309 connections are made. After the Operating System Software 303 completes its boot cycle, the Client Application Software 304 automatically communicates with the Content Distribution Center 312, transmitting its unique identification code (System ID 305), which was previously associated with the configuration file developed through the Web Interface 310. The site-specific content and configuration is then transferred automatically to the Digital Signage Site, after which the Digital Signage system will operate in the site-specific manner.

The present invention addresses the deficiencies in the prior art by allowing a generic Digital Signage system to be configured to the site-specific operation automatically upon connection to the network.

To draw the distinction between the prior art in Digital Signage systems and the present invention more clearly, the present invention uses a pre-loaded, standard software configuration for all systems and automatically loads and configures the site-specific content after power-up through a standard Internet connection.

The present invention is therefore novel in its application of Digital Signage system design technology, and unique in its capabilities, in that it addresses the stated deficiencies in the prior art.

FIG. 24 shows a variation of the System 300 which facilitates an interactive Digital Signage system by adding a Touch Component 304 touch input technology to the system.

As described by the present inventor in previous applications, next-generation Digital Signage systems will likely include camera/speaker/microphone hardware to facilitate real-time bi-directional video communications. Three elements are necessary in order for this type of technology to establish acceptance in the marketplace:

It must be cost effective. With the continuous decline in wide-area and local-area data communications costs, the increased availability of video-over-IP technologies, and the declining costs for the required hardware, the incremental cost of implementation is within reach for many applications and will continue to improve as these costs decline.

It must be presented to users in an acceptable “venue.” The location, functionality, and ergonomic design for these video services must be structured properly in order to achieve widespread consumer acceptance. As described in some detail in previous applications, for common-area commercial applications acceptance is improved dramatically when this functionality is integrated with the traditional information access point, the directory, and physically positioned in the traditional location and in a similar format.

The user experience must be as natural as possible. In this case, one is trying to create a virtual physical meeting between two people who are, in fact, physically separated. Given enough bandwidth and the proper video compression/ decompression technologies, it is now possible to transmit full-motion broadcast-quality images to the screen for the virtual participant in the video conversation. By the same token, the audio elements are also readily available which can closely simulate the “real thing.” However, the one deficiency in prior art is the fact that current implementations must locate the camera outside the direct viewing area for both participants. This results in both participants looking as if they are talking to someone else, making communication difficult and unnatural.

The present invention addresses this deficiency in the prior art by utilizing next-generation flexible display technology to embed the camera in the middle of the display.

FIG. 25 shows a simulated video conversation as would be seen from the perspective of the Live Participant 315. The Virtual Participant 312's face is displayed on the Display Screen 314 through the use of a similar desktop-based video communication system such as shown in the figure for the Live Participant 315. The Camera 313 is shown positioned on top of the Display Monitor 316 housing, which is typical.

FIG. 25 actually illustrates how the Virtual Participant 312 would look in the ideal video communication setup, where the Virtual Participant 312 is looking directly at her camera and therefore appears on the Display Screen 314 to be looking directly at the Live Participant 315. However, this would not be the case in general because the Virtual Participant 312 cannot look at her display face and camera at the same time.

FIG. 26 further illustrates this deficiency in prior art. The same illustration is shown here, except that a Natural Viewing Area 317 is added to show where the Live Participant 315 would be looking during a natural video conversation with the Virtual Participant 312. As can be seen, the Camera 313 is outside this area. As a result, when the Live Participant 315 looks at the Natural Viewing Area 317, the Virtual Participant 312 would see the Live Participant 315 not looking at her, but below her. This problem becomes more pronounced as the size of the Display Screen 314 increases or the distance between the Live Participant 315 and the Camera 313 deceases.

While at first this may not seem like a significant problem, most people who have tried to use this kind of system will readily agree that the experience is awkward and unnatural. The problem is even more pronounced when trying to deploy this kind of service in a public space in conjunction with Digital Signage applications, because the tolerance for these kind of idiosyncrasies by users in this environment is exceptionally low. At the same time, the value for a viable live video service is substantial. Therefore the potential commercial value for solving this deficiency in prior art is significant.

As those familiar with electronic display development know, there is a growing body of research and development in the area of flexible display structures such as illustrated by U.S. Pat. No. 6,762,566 (Micro-component for use in a light-emitting panel; George, et. al.). Unlike current commercial display technologies such as CRT and LCD, these new technologies are particularly well suited to allow for embedding small holes in the display without ruining the integrity of the display system. These holes can, in turn, be used to mount small cameras behind (such as the common CCD camera with pinhole lens) and thereby eliminate the detailed deficiency in the prior art. Even mature display technologies such as plasma could be modified in order to accommodate such a camera with minimal impact on the display pixel structure.

Although the primary focus for the present application is related to improved Digital Signage systems, this invention extends well beyond the Digital Signage application space.

As can be seen by FIG. 26, a camera lens located generally in the Natural Viewing Area 317 would solve the problem. For traditional desktop displays, a single camera lens located near the center of the display would generally provide the required natural viewing experience. For larger displays like those found in Digital Signage applications, multiple cameras may be required.

The present invention addresses the deficiencies in the prior art by integrating the camera into the display face using new commercial display technologies presently under development.

The present invention is therefore novel in its application of camera and display systems, and unique in its capabilities, in that it addresses the stated deficiencies in the prior art.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A system for normalizing pixel usage on an electronic light emitting display panel, the system comprising:
an electronic light emitting display panel; and
a first processor configured to control the display of video content onto said light emitting display panel; and
a second processor and memory configured to calculate the cumulative average usage of all of the pixel elements of said light emitting display panel; and
a means for switching between normal video displayed on said light emitting display panel and a screen conditioning video which uses the stored cumulative averages of the pixels to generate a video that, when displayed onto the light emitting display panel, normalizes the cumulative average usage of the pixels over time.

2. The system of claim 1, the system further comprising: a sensor configured to identify when an individual is within the viewing area of the light emitting display system.

3. The system of claim 2, wherein the sensor comprises a camera configured to recognize an image.

4. The system of claim 2, wherein the sensor comprises an infrared sensor.

5. The system of claim 1, further comprising means for modifying the screen conditioning video in order to correct for variations in the luminosity output of the individual color subpixels of the light emitting display system, when the subpixels' luminosity degrade at different rates over time.

6. The system of claim 1, wherein the first and second processor are comprised within the same housing.

7. The system of claim 1, where the first and second processor are comprised within separate housings.

8. A system for normalizing pixel usage on an electronic light emitting display panel, the system comprising:
an electronic light emitting display panel; and
a processor configured to calculate the cumulative average usage of all of the pixel elements of said light emitting display panel; and
a switch configured to switch between normal video displayed on said light emitting display panel and a screen conditioning video which uses the stored cumulative averages of the pixels to generate a video that, when displayed onto the light emitting display panel, normalizes the cumulative average usage of the pixels over time.

9. A method of normalizing pixel usage on an electronic light emitting display panel, the method comprising:
calculating a usage of the pixel elements of a light emitting display panel;
switching between a normal video display and a screen conditioning video display of the light emitting display panel based on the calculated usage.

10. The method of claim 9, wherein the calculation comprises an average.

11. The method of claim 9, further comprising the step of storing the calculated usage.

12. The method of claim 9, wherein the screen conditioning video display is configured to normalize the cumulative average usage of the pixels over time.
